(19) United States
(12) Patent Application Publication
(10) Pub. No.: US 2011/0246909 A1
(43) Pub. Date: Oct. 6, 2011

(54) ANCILLARY EXPERIENCE-BASED PAIRING

(75) Inventors: Doug Berrett, Seattle, WA (US); Cory Cirrincione, Bellevue, WA (US); Joe McClanahan, Redmond, WA (US); Sean Kollenkark, Seattle, WA (US)

(73) Assignee: MICROSOFT CORPORATION, Redmond, WA (US)

(21) Appl. No.: 12/752,714

(22) Filed: Apr. 1, 2010

(51) Int. Cl. G06F 15/16; G06F 3/01

(52) U.S. Cl. 715/753; 709/204

(57) ABSTRACT

Embodiments are disclosed that relate to ancillary experience-based pairing. One embodiment provides a method comprising displaying content on a display, and displaying a tag on the display along with the content, where the tag comprises an image encoding instructions for pairing with the host computing device. The method further includes, while displaying the tag, receiving registration information from a client computing device, comparing the registration information to expected registration information, and if the registration information matches the expected registration information, then establishing a pairing between the host computing device and the client computing device. The method further includes, upon establishing the pairing, providing an ancillary user experience to the client computing device, where the ancillary user experience including content ancillary to the content.

### BACKGROUND

Various computing devices, such as mobile devices, are configured to pair with other computing devices to allow the devices to communicate with one another. In some cases, pairing may occur via a physical connection by plugging one device into another device. In other cases, pairing may occur over a wireless network, such as a Bluetooth network, a Wi-Fi network, etc. Many current approaches to pairing involve multiple user steps to facilitate the pairing. However, such methods may be cumbersome, and may involve users having to remember and enter code numbers, etc.

### SUMMARY

Various embodiments are disclosed herein that relate to ancillary experience-based pairing of computing devices. For example, one disclosed embodiment provides a method of providing ancillary experience-based pairing comprising displaying content on a display, and displaying a tag on the display along with the content, where the tag comprises an image encoding instructions for pairing with the host computing device. The method further includes, while displaying the tag, receiving registration information from a client computing device, comparing the registration information to expected registration information, and if the registration information matches the expected registration information, then establishing a pairing between the host computing device and the client computing device. Upon establishing the pairing, an ancillary user experience is provided to the client computing device, where the ancillary user experience including content ancillary to the content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of a use environment suitable for ancillary experience-based pairing between a host computing device and a plurality of client computing devices.

FIG. 2 shows a flow diagram depicting an example method of providing ancillary experience-based pairing in accordance with an embodiment of the present disclosure.

FIG. 3 shows a block diagram depicting an example ancillary experience-based pairing of devices in accordance with an embodiment of the present disclosure.

FIG. 4 shows a flow diagram of an example embodiment of a method of joining a user experience provided by a host computing device displaying video content in accordance with an embodiment of the present disclosure.

FIG. 5 shows a schematic depiction of an example ancillary experience-based pairing in accordance with an embodiment of the present disclosure.

### DETAILED DESCRIPTION

As mentioned above, establishing a pairing between computing devices may involve a plurality of user actions. For example, pairing may involve remembering and entering an alphanumerical code or other such relatively cumbersome processes. Such user-involvement is not only time-consuming, but may be error prone. Thus, other approaches have been developed, such as infrared receivers and transmitters, to facilitate pairing and minimize user involvement. For example, rather than manually typing information, the devices may be configured to send data (e.g., a code) via infrared signals.

As more devices are built to include digital cameras, yet another pairing approach has been developed where a device with a digital camera takes a picture of a barcode on an accessory to facilitate pairing with the accessory. This may occur, for example, between a mobile phone and a Bluetooth headset. For example, rather than manually typing the identification code for the headset, a user may use their phone to take a picture of a barcode label on the headset, and the phone can determine the identification code from the image of the barcode label. As such, the discovery and setup of services between the devices can be simplified, which may help reduce user error. However, such pairing methods generally involve pairing to share a primary experience, rather than an ancillary experience. For example, when a Bluetooth headset is paired with a phone, the headset merely acts as a different receiver and speaker for the experience occurring on the telephone, rather than receiving and presenting other content related to this experience.

Ancillary experience-based pairing as disclosed herein allows a client computing device to join a user experience associated with content provided by a host computing device by pairing with the host computing device to receive content ancillary to the content from the host device. Examples of ancillary experiences include, but are not limited to, audio content that accompanies video content being displayed by the host device, an interactive user experience (e.g., a fan web site for a sports video presentation), chat room related to the video content, etc. As such, a user can view and/or listen to ancillary content on a personal device, such as a mobile device, laptop computer, notebook computer, etc.

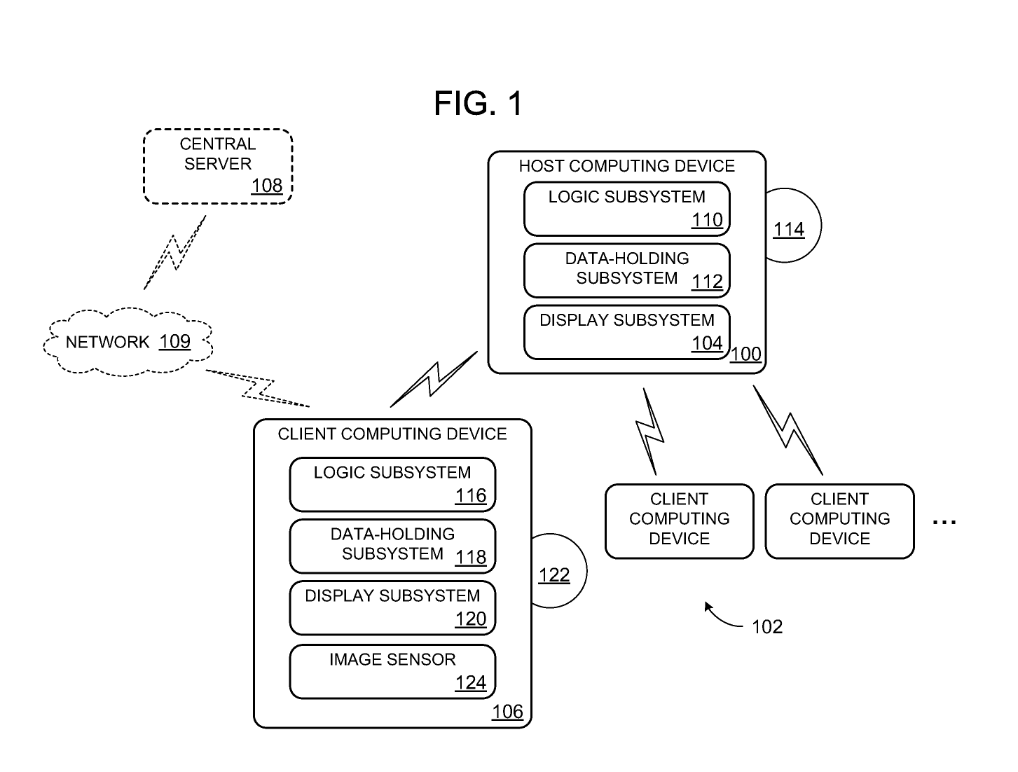

FIG. 1 shows an embodiment of ancillary experience-based pairing between an example host computing device 100 and a plurality of example client computing devices 102. It will be understood that other embodiments may provide one-to-one pairing, rather than one-to-many pairing, with a host computing device. Host computing device 100 may be configured to provide content, such as video content, audio content, digital photographs, electronic games, etc. Host computing device 100 may be configured to display video content, for example, via a display subsystem 104. Further, as described in more detail below, host computing device 100 may be configured to display a tag associated with the content being provided, wherein the tag comprises an image encoding instructions for pairing to the host computing device. Users of client computing devices 102 that desire to join the user experience associated with the content being provided by host computing device 100 may pair with the host computing device simply by capturing an image of the tag. The client computing device may then follow the instructions in the tag to establish the pairing to receive the ancillary experience.

It will be appreciated that although embodiments are described herein in the context of a tag being displayed with video content, a tag may be displayed with other content (e.g., audio content, digital photographs, electronic games, etc.) without departing from the scope of this disclosure.

Such pairing may facilitate pairing in environments where multiple different pairing experiences are available to users. For example, in a sports bar with multiple televisions all displaying different games and all having separate ancillary experiences available to patrons, a patron may select a desired ancillary experience by capturing an image of the tag displayed on the specific television of interest. The client then may follow the instructions encoded in the tag to accomplish the pairing process to begin receiving the ancillary experience associated with that particular television. In this manner, the patron can easily pair to receive the ancillary experience of interest without having to view a list of devices available for pairing, determine which device on the list is the device of interest, and perform manual pairing with that device. Such an ancillary experience may comprise, for example, game stats, team stats, audio of the game, product placement, and the like. It can be appreciated that these example are presented for the purpose of example, and are not intended to be limiting in any manner. Further, in some embodiments, the display may be separately controlled, and therefore may not have any particular intelligence other than that for displaying images.

Continuing with FIG. 1, in some embodiments, client computing devices 102 may be configured to access host computing device 100 directly. In other words, the instructions encoded in the tag include a network address for the host computing device 100, or other information that allows the client computing devices 102 to directly contact the host computing device. Client computing devices 102 may be configured to access host computing device 100 via any suitable communication protocol and/or network, including but not limited to Wi-Fi, Bluetooth, etc.

Additionally or alternatively, the tag may encode instructions for accessing host computing device 100 via a central server 108. As an example, host computing device 100 may have been previously registered with central server 108 such that central server 108 stores address information and/or accessibility instructions for host computing device 100. In such a case, when provided with an address to central server 108, client computing device 106 may contact central server 108 to obtain an address (and potentially other pairing instructions, such as authentication information, a list or sequence of acts to perform to accomplish pairing, etc.) for accessing host computing device 100. Client computing devices 102 may be configured to access central server 108 via any suitable communication protocol and/or via any suitable network 109, including but not limited to a local area network, wide area network such as the Internet, etc.

As mentioned above, after establishing a pairing with a client computing device, host computing device 100 is configured to provide a client device with an ancillary experience that is a companion experience to the video content being displayed. Accordingly, the ancillary experience includes content ancillary to the video content being displayed. In other words, the ancillary experience may include content that is somehow related to the video content on the host device. As an example, the ancillary user experience may include audio content corresponding to the video content, such as the audio for a television show being displayed on display subsystem 104 (where the television itself is not outputting the audio via its speakers). As another example, the ancillary user experience may include television programming for another show that is related to a television show being displayed on display subsystem 104. As yet another example, the ancillary user experience may include an interactive social experience ancillary to the video content, such as a social networking site for a movie being displayed on display subsystem 104. As such, the ancillary experience may include a full, in-depth, immersive experience associated with the video content.

Continuing with FIG. 1, host computing device 100 includes a logic subsystem 110 and a data-holding subsystem 112. Host computing device 100 may further be configured to read a computer-readable removable media 114, which may be used to store and/or transfer data and/or instructions executable to implement the herein described embodiments. Nonlimiting examples of computer-readable removable media 114 include a DVD, a CD, a disk, etc. Host computing device 100 may further include various other components not shown in FIG. 1.

Logic subsystem 110 may include one or more physical devices configured to execute instructions stored in data-holding subsystem and/or on removable media 114, including but not limited to instructions executable to provide ancillary experience-based pairing as described herein. Such instructions may be part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 112 may be any suitable computer-readable storage medium, and may include one or more physical, non-transitory, devices configured to hold data and/or instructions executable by the logic subsystem to implement the herein described methods and processes. When such methods and processes are implemented, the state of data-holding subsystem 112 may be transformed (e.g., to hold different data). Data-holding subsystem 112 may include removable media and/or built-in devices. Data-holding subsystem 112 may include optical memory devices, semiconductor memory devices, and/or magnetic memory devices, among others. Data-holding subsystem 112 may include devices with one or more of the following characteristics: volatile, nonvolatile, dynamic, static, read/write, read-only, random access, sequential access, location addressable, file addressable, and content addressable. In some embodiments, logic subsystem 110 and data-holding subsystem 112 may be integrated into one or more common devices, such as an application specific integrated circuit or a system on a chip.

Display subsystem 104 may be used to present a visual representation of data held by data-holding subsystem 112. As the herein described methods and processes change the data held by the data-holding subsystem, and thus transform the state of the data-holding subsystem, the state of display subsystem 104 may likewise be transformed to visually represent changes in the underlying data. Display subsystem 104 may include one or more display devices utilizing virtually any type of technology. Such display devices may be combined with logic subsystem 110 and/or data-holding subsystem 112 in a shared enclosure, or such display devices may be peripheral display devices.

Client computing device 106 also comprises a logic subsystem 116, a data-holding subsystem 118, and a display subsystem 120. Client computing device 106 further may optionally include computer-readable removable media 122 and/or other components not shown in FIG. 1.

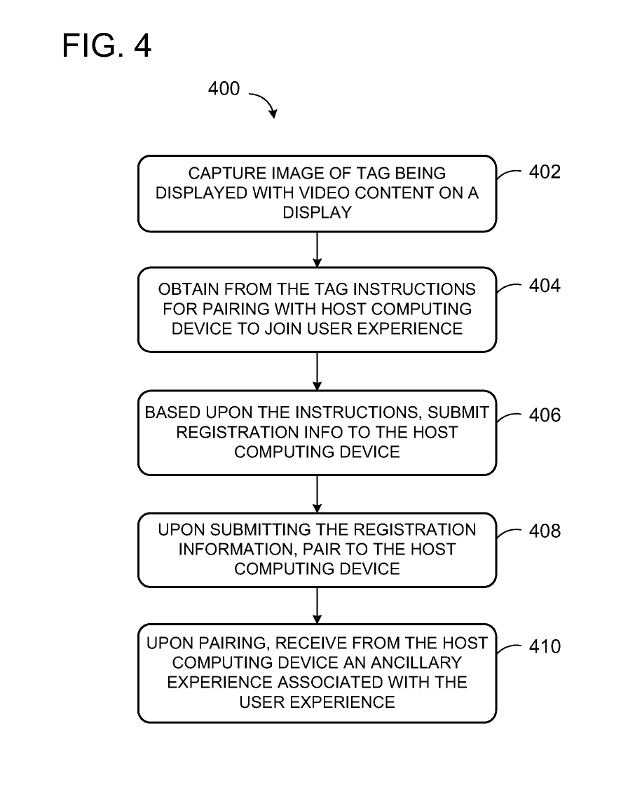

Logic subsystem 116 of client computing device 106 may include one or more physical devices configured to execute one or more instructions, such as a method of joining a user experience provided by a host computing device displaying video content, as described in more detail hereafter with reference to FIG. 4. Client computing device 106 further includes an image sensor 124. Image sensor 124 may be any suitable image sensor for obtaining image data via scanning, capturing, etc. As a nonlimiting example, client computing device 106 may include a digital camera capable of capturing image data via image sensor 124.

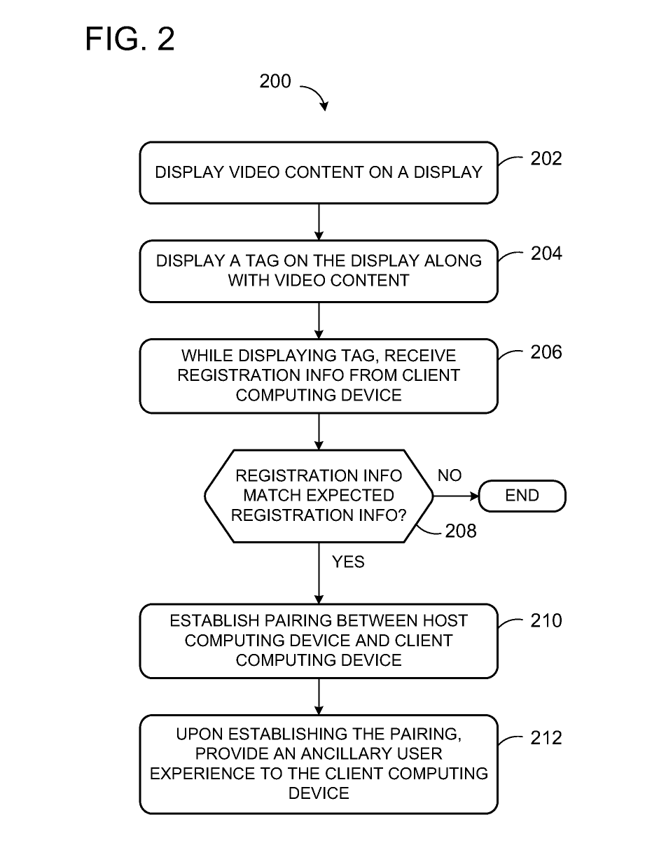

FIG. 2 shows a flow diagram depicting an example embodiment of a method 200 of providing ancillary experience-based pairing. Such a method may be executed, for example, by host computing device 100. At 202, method 200 includes displaying video content on a display. Examples of the video content include, but are not limited to, television, movies, video clips, streaming video, Internet Protocol television (IPTV), etc., and may or may not include accompanying audio. Nonlimiting examples of a display include any suitable display device such as a television, computer monitor, projection device (e.g., at a movie theater), etc. It will be appreciated that the display may be separately controlled, and therefore may not have any particular intelligence other than that for displaying images.

It can be further appreciated that while method 200 is described in the context of the tag being displayed with video content, the tag may alternatively be displayed with other types of content without departing from the scope of this disclosure.

At 204, method 200 includes displaying a tag on the display along with the video content. As mentioned above, the tag includes an image encoding instructions for pairing with the host computing device. In some embodiments, the tag may be displayed inline with the video content on the display in the form of a supplemental graphic. Further, since the tag has encoded instructions, displaying the tag may include providing a visual signature that may be used for authentication when pairing. The tag may have any suitable form on the display. Examples of suitable tags include, but are not limited to, a unique image, a two dimensional barcode, a QR code, etc. Further, in some embodiments the tag may be configured to have a low visibility to the human eye when displayed. Such tags may comprise light-colored pixels, white pixels, faintly shaded pixels (e.g., a watermark), etc. In other embodiments, a tag maybe configured to be invisible to the human eye (e.g., an infrared image), but visible to a machine vision system. Such a tag may be scanned/captured by an image capture device on a client computing device, as described in more detail with reference to FIG. 4.

The tag may be displayed for any suitable duration. For example, the tag may be displayed for an entire duration of a video content item (e.g. television show, movie, streaming video clip, etc.). In other embodiments, the tag may be displayed intermittently, or for a fixed-duration interval(s) that is shorter in duration than the video content item. As yet another example, the tag may be displayed in response to an explicit act, such as in response to receiving a request from a client computing device to pair with the host computing device. In other words, a request from the client computing device to pair with the host computing device may be received prior to displaying the tag.

The instructions (e.g., data) encoded within the tag for pairing with the host device may be any suitable instructions identifying the host device and providing a mechanism to begin communication and/or perform registration. For example, the instructions for pairing with the host computing device may include instructions for directly accessing the host computing device, including a network address for the host computing device, authentication information, etc. Additionally or alternatively, the host computing device may be registered with a central server, in which case the instructions for pairing with the host computing device may include instructions for accessing the central server. As another example, the instructions may include instructions regarding one or more actions to take to pair with the host computing device, and any associated data used with the actions. The instructions may additionally or alternatively include other information, such as an encoded set of numbers, a Globally Unique Identifier (GUID), binary data, etc.

At 206, method 200 includes, while displaying the tag, receiving registration information from a client computing device. The registration information may include any suitable information, including but not limited to information corresponding to image data captured by an image sensor of the client computing device, client identification information, etc.

Upon receiving the registration information, method 200 next includes, at 208, comparing the registration information to expected registration information to determine if the registration information matches the expected registration information. In the case of the aforementioned example where the registration information includes image data captured by the client computing device, verifying the registration information may include comparing the image data to expected image data corresponding to the tag.

In some embodiments, registration may be “anonymous” such that the host computing device does not send authentication information to the client computing device, while in other embodiments, a two-way authentication may be used to establish pairing.

If it is determined at 208 that the registration information does not match the expected registration information, then method 200 ends. However, if it is determined that the registration information matches the expected registration information, method 200 proceeds to 210. At 210, method 200 includes establishing a pairing between the host computing device and the client computing device. Next, at 212, method 200 includes, upon establishing the pairing, providing an ancillary user experience to the client computing device. As mentioned above, the ancillary user experience may include content ancillary to the video content. Examples of ancillary user experiences include, but are not limited to, audio content corresponding to the video content, additional video content related to the video content, and/or an interactive social experience ancillary to the video content.

The ancillary user experience-based pairing may be established for any suitable duration. As an example, the pairing may be transient, lasting for a duration of a video content item (e.g., a television episode), for a duration of an object of interest in a video content item (e.g., product placement), etc. In other embodiments, the pairing may last for multiple video content items, or may persist until the client unpairs, until a network connection with the client is lost, etc.

It will be understood that method 200 may support one-to-one or one-to-many registration, such that either a single client computing device or multiple client computing devices can pair with a single host computing device. For example, in the case of the earlier-described sports bar example, each television showing a game may be configured to provide ancillary experience-based pairing to many companion devices, such that multiple patrons may receive the ancillary experience for each displayed game.

In some embodiments, the host computing device may be configured to display multiple tags for a video content item, where each tag is associated with a different ancillary experience-based pairing. Further, it will be understood that, in some situations, each video content item displayed by the host computing device may be associated with a different tag (e.g., where the ancillary experience is associated with the specific video content being displayed). In such embodiments, the host computing device may be further configured to display a second video content item, and to facilitate ancillary experience-based pairing corresponding to a second ancillary user experience associated with the second video content item. In other situations, a single tag may be displayed for the duration of plural video content items (e.g., where the ancillary experience is related to some aspect of the plural video content items being displayed, such as where the plural video content items share a common genre, actor, director, etc.).

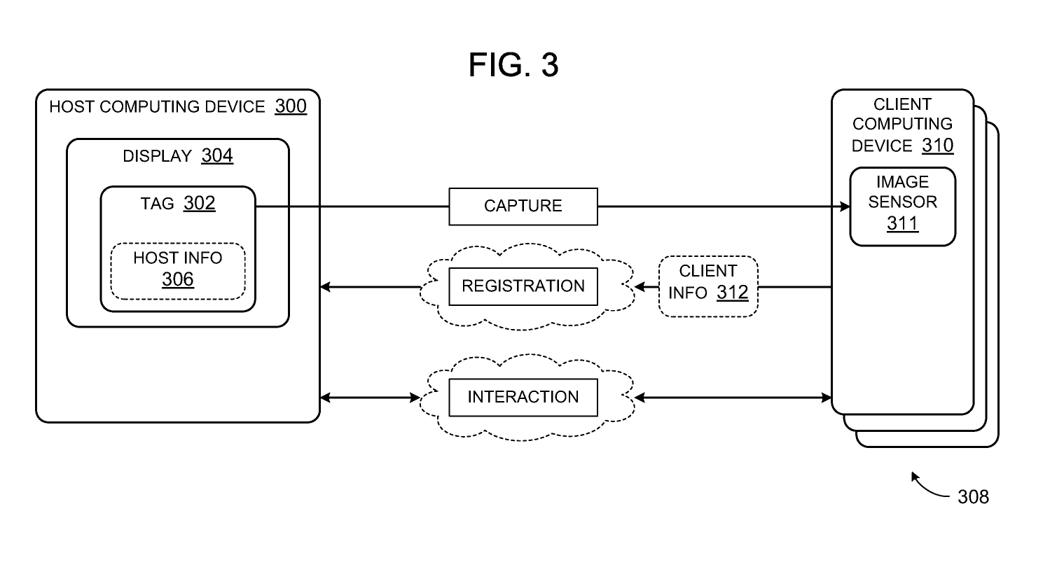

FIG. 3 shows a block diagram illustrating an example of ancillary experience-based pairing between a host computing device 300 and one or more client computing devices 308. Host computing device 300 may first display a tag 302 on a display 304, for example, along with video content being displayed by display 304. As described above, the tag 302 may include host information 306, such as instructions regarding how to pair with the host computing device. In various embodiments, the host information 306 may include an address of the host computing device 300 itself, or an address (e.g. a Uniform Resource Locator) for contacting a central server which can provide the address to host computing device 300.

One or more of client computing devices 308 may capture an image of tag 302 via an image sensor, such as example client computing device 310 with image sensor 311. Client computing device 310 may then read the instructions encoded in the tag, and send client registration information 312 to the host computing device 300. Client registration information may include, for example, a client identification, a client network address, image data captured by client computing device 310, and/or any other suitable information.

Upon receiving the client registration information 312, the host computing device may verify the client registration information and finish registration, and thus pair with the client computing device 310. Host computing device 300 can then establish an interaction between the host computing device and client computing device 310 and begin to provide the ancillary experience to client computing device 310, as indicated by “interaction” in FIG. 3.

FIG. 4 illustrates a method 400 of joining a user experience provided by a host computing device displaying video content. Such a method may be performed, for example, by a client computing device having an image sensor, such as example client computing device 106 of FIG. 1 and/or example client computing device 310 illustrated in FIG. 3.

At 402, method 400 includes capturing with the image sensor an image of a tag being displayed with the video content on a display of the host computing device. As described herein, the tag may contain instructions for pairing with the host computing device to join the user experience associated with the video content.

In some embodiments, the tag may be displayed inline with the video content on the display in the form of a supplemental graphic. In other embodiments, the tag may be displayed in response to an explicit act. For example, a user of a client computing device desiring to pair with the host device may instruct the client device (e.g., via a user interface control) to initiate a pairing process with a host computing device. The client computing device then sends a request to the host computing device to display a tag. Therefore, in such an embodiment, method 400 may include, before capturing the image of the tag, submitting a request to the host computing device for displaying the tag with the video content on the display.

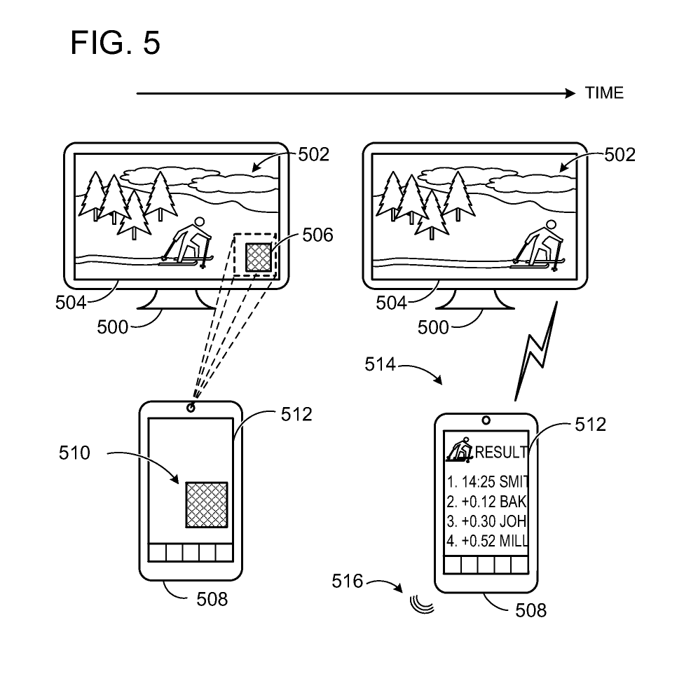

As an example, FIG. 5 shows a schematic depiction of such a pairing process. In this example, a host computing device 500 displays video content 502 on a display 504, and also displays a tag 506. A client computing device 508 captures an image 510 of the tag 506 via a camera located on the client computing device 508.

Returning to FIG. 4, at 404, method 400 includes obtaining from the tag the instructions for pairing with the host computing device to join the ancillary user experience. In some embodiments, the instructions for pairing with the host computing device include instructions for directly accessing the host computing device (e.g., independent of a central server), while in other embodiments, the instructions may include information for contacting a central server. For example, the host device may be registered with a central server, such that the central server can provide information for initiating communication with the host computing device. In such a case, the client computing device, after obtaining the instructions from the tag, may contact the central server, receive information from the central server regarding connecting to the host computing device, and based on the information, connect to the host computing device.

At 406, method 400 includes submitting registration information to the host computing device based upon the instructions for pairing with the host computing device. Such registration information may contain, for example, image data corresponding to the image of the captured tag, client identification information, and/or any other suitable information.

At 408, method 400 includes, upon submitting the registration information, pairing with the host computing device. At 410, method 400 includes, upon pairing with the host computing device, receiving from the host computing device an ancillary user experience associated with the user experience.

In the embodiment depicted in FIG. 5, the ancillary user experience may include content ancillary to video content 502, such as video content (illustrated schematically at 514) and/or ancillary content 516 (e.g., audio content). For example, if video content 502 is a televised ski race, ancillary content 514 and/or ancillary content 516 may include an audio track for the race, race updates, results updates, related results, related races, sponsorship, etc. As another example, if video content 502 is a movie presented at a movie theater, ancillary content 514 and/or ancillary content 516 may comprise information related to the movie, such as a character listing, trivia, reviews, suggested movies having similar actor(s) and/or plot, etc.

In yet other embodiments, ancillary experience-based pairing as described herein may be used to facilitate communication between two computing devices. For example, a first computing device could be used as a “broker” to facilitate communication between two other computing devices. As an example, a mobile phone could be used to pair two computing devices that are not in physical proximity.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a host computing device configured to provide content ancillary to content being displayed on a display, a method of providing ancillary experience-based pairing, comprising:
displaying content on the display;
displaying a tag on the display along with the content, the tag comprising an image encoding instructions for pairing with the host computing device;
while displaying the tag, receiving registration information from a client computing device;
comparing the registration information to expected registration information, and if the registration information matches the expected registration information, then establishing a pairing between the host computing device and the client computing device; and
upon establishing the pairing, providing an ancillary user experience to the client computing device, the ancillary user experience including content ancillary to the content.

2. The method of claim 1, wherein the content comprises video content.

3. The method of claim 1, wherein the registration information includes information corresponding to image data captured by an image sensor of the client computing device, and wherein comparing the registration information to the expected registration information includes comparing the information corresponding to the image data to expected image data corresponding to the tag.

4. The method of claim 1, further comprising, prior to displaying the tag, receiving a request from the client computing device to pair with the host computing device.

5. The method of claim 1, wherein the instructions for pairing with the host computing device include instructions for directly accessing the host computing device.

6. The method of claim 1, wherein the host computing device is registered with a central server, and wherein the instructions for pairing with the host computing device include instructions for accessing the central server.

7. The method of claim 1, wherein the tag comprises one or more of a two dimensional barcode, an infrared image, a QR code, and a watermark within the content.

8. The method of claim 2, wherein the ancillary user experience comprises one or more of audio content corresponding to the content and an interactive social experience ancillary to the content.

9. The method of claim 2, wherein the content comprises a video content item, and wherein providing the ancillary user experience comprises providing a transient pairing with the client computing device for a duration of the video content item.

10. The method of claim 9, wherein the video content item comprises a first video content item, wherein the tag comprises a first tag, and wherein the host computing device is further configured to display a second video content item with a second tag, the second tag being configured to facilitate ancillary experience-based pairing corresponding to a second ancillary user experience associated with the second video content item.

11. The method of claim 1, further comprising receiving registration information from each of a plurality of client computing devices, and for each of the plurality of client computing devices:
comparing the registration information from that client computing device to the expected registration information; if the registration information matches the expected registration information, then establishing a pairing between the host computing device and that client computing device; and, upon establishing the pairing, providing the ancillary user experience to that client computing device.

12. On a client computing device comprising an image sensor, a method of joining a user experience provided by a host computing device displaying video content, the method comprising:
capturing with the image sensor an image of a tag being displayed with the video content on a display of the host computing device, the tag containing instructions for pairing with the host computing device to join the user experience associated with the video content;
obtaining from the tag the instructions for pairing with the host computing device to join the user experience;
based upon the instructions for pairing with the host computing device, submitting registration information to the host computing device;
upon submitting the registration information, pairing to the host computing device; and
upon pairing to the host computing device, receiving from the host computing device an ancillary user experience associated with the user experience, the ancillary user experience including content ancillary to the video content.

13. The method of claim 12, wherein the instructions for pairing with the host computing device include instructions for directly accessing the host computing device.

14. The method of claim 12, further comprising contacting a central server, receiving information from the central server regarding connecting to the host computing device, and based on the information, connecting to the host computing device.

15. The method of claim 12, wherein the tag comprises one or more of a two dimensional barcode, an infrared image, a QR code, and a watermark within the video content.

16. The method of claim 12, wherein the video content comprises a video content item, and wherein receiving the ancillary user experience comprises receiving a transient pairing with the host computing device for a duration of the video content item.

17. The method of claim 12, further comprising, before capturing the image of the tag, submitting a request to the host computing device for displaying the tag with the video content on the display.

18. On a host computing device comprising a display, a method of providing an ancillary user experience to video content displayed on the display, the method comprising:
displaying a video content item on the display;
displaying a tag along with the video content item on the display, the tag comprising an image encoding information identifying the host computing device and also encoding instructions for a client computing device to join a user experience associated with the video content item;
upon displaying the tag, receiving registration information from a client computing device;
verifying the registration information;
upon verifying the registration information, establishing a pairing between the host computing device and the client computing device; and
upon establishing the pairing, providing the ancillary user experience associated with the video content item to the client computing device, the ancillary user experience including content ancillary to the video content item.

19. The method of claim 18, wherein providing the ancillary user experience comprises providing an ancillary experience-based pairing with the client computing device for a duration of the video content item.

20. The method of claim 18, wherein the ancillary user experience comprises an interactive social experience ancillary to the video content of the user experience.
